(19) United States
(12) Patent Application Publication
(10) Pub. No.: US 2022/0036722 A1
(43) Pub. Date: Feb. 3, 2022

(54) EMERGENCY REMOTE DATA ACCESS BASED ON AN EMERGENCY COMMUNICATION LINK AND SENSOR DATA

(71) Applicant: Healthcare Integrated Technologies Inc., Knoxville, TN (US)

(72) Inventors: Kenneth M. GREENWOOD, Davenport, FL (US); Scott Michael BORUFF, Knoxville, TN (US); Jurgen VOLLRATH, Sherwood, OR (US)

(21) Appl. No.: 17/390,806

(22) Filed: Jul. 30, 2021

Related U.S. Application Data
(60) Provisional application No. 63/103,417, filed on Aug. 3, 2020.

(51) Int. Cl. G08B 25/00; G08B 27/00; H04W 4/90; G08B 29/00; G08B 21/14

(52) U.S. Cl. CPC G08B 25/006; G08B 27/001; G08B 21/14; G08B 29/00; H04W 4/90

(57) ABSTRACT

A method and system for improving the safety of the environment for an occupant of a dwelling which includes providing the dwelling with monitors and sensors to detect emergencies and a communication system that permits hands-free communication with responding parties and historic and/or real-time imaging feed of the inside of the dwelling to the responding parties.

### FIELD OF THE INVENTION

The invention relates to home security and improving response by first responders.

### BACKGROUND OF THE INVENTION

It is common these days to find carbon monoxide detectors, smoke detectors and fire alarms in buildings. Many occupants also supplement their homes with intruder alert systems that are coupled to a responding party or entity together with an imaging feed of the premises. However, these systems aren't fail-safe. Smoke alarms easily get triggered while cooking, and burglar alarms inadvertently get activated by the occupant.

It is up to the occupant to deal with the false emergency, either by trying to air out the room in order to subdue the annoying racket of the smoke alarm, or by calling a burglar alarm response number in order to clarify that the triggered alarm was a false alarm.

And when there is a real emergency, response teams are often hampered because they do not know prior to or even at the time of arrival, the nature or extent of the emergency. Firefighters, for example, may not know ahead of time whether they are dealing with localized or widespread fire in an apartment, whether the occupant is unconscious, how many occupants are in the apartment, and where those occupants might be located in the apartment. Also, they may not have a means of communicating with the people in the apartment.

### SUMMARY OF THE INVENTION

According to the invention, there is provided an emergency alert and response system for a dwelling space, comprising at least one dwelling sensor, a communications system comprising at least one speaker and at least one microphone for hands free communication between the occupant and designated parties, at least one image sensor for capturing image data, comprising one or more of cameras operating in the visual spectrum, image sensors operating according to different modalities such as direct-temperature sensing, ultrasonic motion detectors, and image sensors operating at different frequencies or in different frequency bands such as infrared, thermal, lidar, and radar, and a processor connected to a memory configured by means of machine-readable code to identify emergency events based on the number of anomalies detected and/or based on corroboration of an anomaly by one sensor with data from at least a second sensor to define an emergency event, wherein the communications system is configured for real-time sensor data streaming from the at least one sensor to one or more designated third-parties or entities in response to an emergency event.

For purposes of this application, image sensors and dwelling sensors will be referred to collectively as sensors.

The machine-readable code may be configured to identify the appropriate designated third-parties or entities to contact via the response system based on the type of emergency. The dwelling sensor(s) may include one or more of: a carbon monoxide detector, a smoke detector, a fire alarm, a stove-left-on alarm, a moisture sensor, a strain gauge for detecting shifts or movement in structural components of a home, thermal sensor, ultrasonic sensor, infrared sensor, a microphone listening for structural noises or other events that may be affecting a person in the residence, stove-left-on sensor, moisture sensor, strain gauge, accelerometer, and microphone.

The system may also include an external monitoring system that includes the capture or relaying of public emergency reports and information; and may include at least one occupant sensor, comprising imaging sensors, audio sensors, and/or health monitors, for monitoring physiological parameters of occupants of the dwelling. The health monitors, in turn, may include a sphygmomanometer (blood pressure), heart rate, ECG, blood oxygenation, and/or genetic sensors. The audio or imaging sensors may also function as health monitors for detecting one or more of heart rate, breathing patterns and breathing anomalies.

The external monitoring system may include monitoring devices for receiving public broadcasts and emergency notifications, including one or more of emergency broadcasts, reports and read-outs from earthquake sensors, weather alerts, tidal wave monitors, tornado and hurricane monitors and warnings, mass shooter alerts, infection disease warning, air raid warnings, and nuclear alerts.

The real-time sensor data streaming may include streaming of imaging data in one or more frequency bands or formats, including visual, infra-red and radio.

In a preferred embodiment, the response system includes a voice activated system.

Further, according to the invention, there is provided a method of enhancing the safety of an occupant of a dwelling space, comprising: monitoring the dwelling space for safety concerns associated with the dwelling space by means of at least two safety sensor, identifying potential emergency events based on safety sensor information, verifying a potential emergency event that has been identified by one safety sensor, by means of information from at least a second safety sensor, and in the event of an emergency event being verified, notifying at least one of: the occupant, and one or more of authorized third-parties that have been identified as being the most appropriate third-parties based on the nature of the verified emergency.

The safety sensors may include an image sensor, the method comprising providing said authorized third-parties with voice communication with the occupant, and live data streaming from one or more image sensors.

The method may include monitoring the occupant's health by means of safety sensors that include health sensor information and using an AI network to identify anomalies in the health sensor information over time or anomalies compared to other persons in similar situations.

The method may further comprise monitoring emergency situations outside the dwelling space and notifying one or more of: the occupant and authorized third-parties of relevant events that may affect the occupant.

The monitoring of the dwelling space may include monitoring for unauthorized intruders.

Both image sensor data and other safety sensor data may be provided to authorized third-parties, and may include at least one of historical data and real-time streaming data, to inform about one or more of: the nature of the emergency, the location of the emergency, the origin of the emergency, and the situation and location of the occupant.

Providing the authorized third-parties with voice communication with the occupant may include providing a voice-activated communications system in the dwelling space.

Still further, according to the invention, there is provided an emergency detector system for a building, comprising at least one dwelling sensor, at least one image sensor for receiving image data at one or more frequencies, a processor connected to memory configured with machine-readable code defining an algorithm for analyzing the data from the at least one dwelling sensor and one or more image sensors to detect a potential emergency event and corroborate said event detected by one sensor with data from at least one other sensor, and a communications system for alerting an emergency response team or other entity in the event of a corroborated emergency event, and providing them with access to at least one of: historical sensor data over time, and current streaming of sensor data from one or more sensor.

The emergency detector system may further include a second communications system that includes a microphone and a speaker in the building for direct communication between the emergency response team or other entity and occupants in the building.

At least one dwelling sensor may include one or more of: a carbon monoxide detector, a smoke detector, a fire alarm, a stove-left-on alarm, a moisture sensor, a strain gauge for detecting shifts or movement in structural components of a home, thermal sensor, ultrasonic sensor, infrared sensor, a microphone listening for structural noises or other events that may be affecting a person in the residence, stove-left-on sensor, moisture sensor, strain gauge, accelerometer, fall detector, and microphone.

One or more image sensors may include at least one of an imaging camera operating in the visual spectrum, an image sensor operating in the infra-red spectrum, a lidar system, and a radar system.

The second communications system may comprise a voice activated communications system.

### BRIEF DESCRIPTION OF THE DRAWINGS

FIG. 1 is a depiction of one embodiment of the implementation of a system of the invention;

FIG. 2 is a flow chart defining the logic of one embodiment of an anomaly detection algorithm implemented in an AI system;

FIG. 3 is a flow chart defining the logic of one embodiment of an anomaly detection and corroboration algorithm implemented in an AI system, and

FIG. 4 is a depiction of one embodiment of a user interface for first responders.

### DETAILED DESCRIPTION OF THE INVENTION

It will be appreciated that the present invention can be implemented in different ways, with a variety of sensors and covering a variety of security features.

These security features may include:
a. Notifying occupants and responders to dangerous or catastrophic events that occur within a dwelling or home, e.g. fires, pipe bursts or other forms of internal flooding, structural problems that may be caused by external weather systems or age-related decay, etc. These can be measured or monitored using carbon monoxide detectors, smoke detectors, fire alarms, stove-left-on alarms, moisture sensors, strain gauges for detecting shifts or movement in structural components of a home, microphones listening for structural noises or other events that may be affecting a person in the residence, etc.
b. Notifying occupants of external events that may pose a danger to an occupant or a home, e.g., earthquakes, hurricanes, tornadoes, tsunamis, infectious diseases, air raids, reports of crime or civil unrest in the area. These may be monitored using sensors and monitoring systems, including monitoring public announcements (news, warnings) etc. For instance, an occupant may be warned about potentially dangerous events through earthquake monitoring, weather alerts, tidal wave monitors, tornado and hurricane monitoring, mass shooter alerts, infection disease warning, air raid warnings, and nuclear alerts.
c. Monitoring occupants of a dwelling for health issues and risks. This may be monitored using user-specific sensors, also referred to herein as occupant sensors. These may include imaging sensors, audio sensors, and health monitors.

The occupant sensors may be directed to a specific ailment that an occupant is afflicted with, or may be of a more generic nature to provide ongoing health monitoring. For example, occupant sensors may include a sphygmomanometer for measuring blood pressure, a heart rate monitor, electrocardiogram (ECG), blood oxygenation sensor, and genetic sensors. These sensors/monitors may be non-contact (also referred to herein as ambient sensors), e.g. a wall-mounted fall detector for detecting a person falling, or a microphone or audio sensor for detecting a person falling or some other anomalous sound. An audio sensor may also act as a direct health monitor, e.g., for detecting heart rate, breathing patterns and change in breathing patterns of an occupant. The sensors/monitors may also take the form of wearable devices, e.g. watches or pendants, or ad hoc medical sensors that are applied to an occupant, e.g. blood pressure cuff.

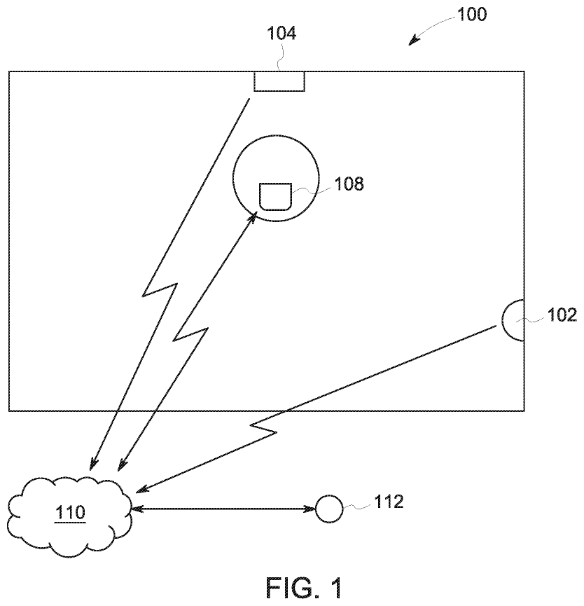

A simple implementation of a system of the invention is shown in FIG. 1, which shows a plan view of a room 100 that includes a smoke sensor, carbon monoxide sensor or fire alarm 102. The room 100 is also provided with an image sensor 104, which may take the form of an imaging camera or a set of cameras operating in the visual and/or infra-red spectrums, or may comprise a Lidar, Radar or other image sensor, the function of which is preferably not impeded by smoke.

The room also includes a hands-free communications system (also referred to herein as a call system) 108, which may be implemented as a voice-bot, robot, or other voice-activated communications system. The hands-free system may also include a visual occupant interface, e.g. a screen allowing a guest or occupant in the dwelling to initiate a call and to see the party(s) they are speaking with. In this embodiment, the call system 108 communicates with entities outside of the dwelling via a server 110, which in this embodiment is implemented as a cloud server system.

In the event that an emergency has been initiated from the dwelling by the system, the response team may also then initiate a call into the dwelling and attempt to communicate with the occupants via audio and/or imaging sensors, and analyze the data being transmitted from the sensors, and/or data recently recorded in the cloud.

According to one aspect of the invention, historic or real-time data from one or more of the sensors or monitors may be accessible by authorized persons or entities e.g. first responders, permitting them to assess the progression and severity of events relevant to an alert, and possibly current state of the environment in the dwelling and the location and state of the occupants, prior to and/or upon arrival at the dwelling. In this embodiment the visual data feed from the image sensor 104, and the information from the smoke sensor, carbon monoxide sensor or fire alarm 102 are captured remotely by transmission to the server 110. In one embodiment only the dwelling sensor, e.g., triggering of the smoke sensor, carbon monoxide sensor or fire alarm 102 is captured, which may comprise a voltage change in the smoke sensor, carbon monoxide sensor or fire alarm 102 when triggered. In another embodiment the dwelling sensor data may be corroborated by a second sensor, e.g. an audio sensor, or image sensor.

By capturing both the smoke sensor, carbon monoxide sensor or fire alarm 102 information and the image sensor 104 data, the image data can serve to validate the triggering data of the smoke sensor, carbon monoxide sensor or fire alarm 102 by identifying corroborating information, e.g. visual confirmation of smoke or a fire, or identifying someone lying on the ground, slumped over a chair or couch, or identifying some other anomaly, e.g., not getting up from a bed based on a previously identified sleep pattern. As discussed above, the call system 108 also transmits its communications via the server, thereby allowing any communications between an occupant and a second party to be saved in memory and also to provide yet another source for validating sensor data.

In some cases, the evidence provided by one sensor may be compelling enough to elevate an anomaly to the level of a triggering event (also referred to herein as an emergency event or flagging event). This may be based on grading the degree to which the anomaly conforms to previously captured data that is indicative of an event.

In other cases or other embodiments, the evidence from one sensor may be insufficient to indicate a triggering event, in which case corroboration of the first sensor's anomaly data may be required by analyzing data from at least one other sensor, or from a microphone or image capture device, for the same or a related time-frame.

In one embodiment, the anomaly analysis is implemented in software and involves logic in the form of machine readable code defining an algorithm or implemented in an artificial intelligence (AI) system, which is stored on a local or remote memory (as discussed above), and which defines the logic used by a processor to perform the analysis and make assessments.

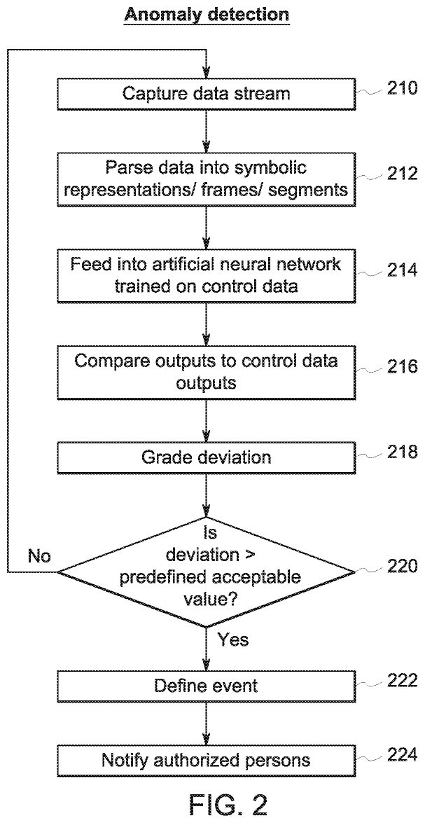

One such embodiment of the logic based on grading the level of the anomaly, is shown in FIG. 2, which defines the analysis based on sensor data that is evaluated by an Artificial Intelligence (AI) system, in this case an artificial neural network. Data from a sensor is captured (step 210) and is parsed into segments (also referred to as symbolic representations or frames) (step 212). The symbolic representations are fed into an artificial neural network (step 214), which has been trained based on control data (e.g. similar previous events involving the same party or parties or similar third-party events). The outputs from the AI are compared to outputs from the control data (step 216) and the degree of deviation is graded in step 218 by assigning a grading number to the degree of deviation. In step 220 a determination is made whether the deviation exceeds a predefined threshold, in which case the anomaly is registered as an event (step 222) and one or more authorized persons is notified (step 224)

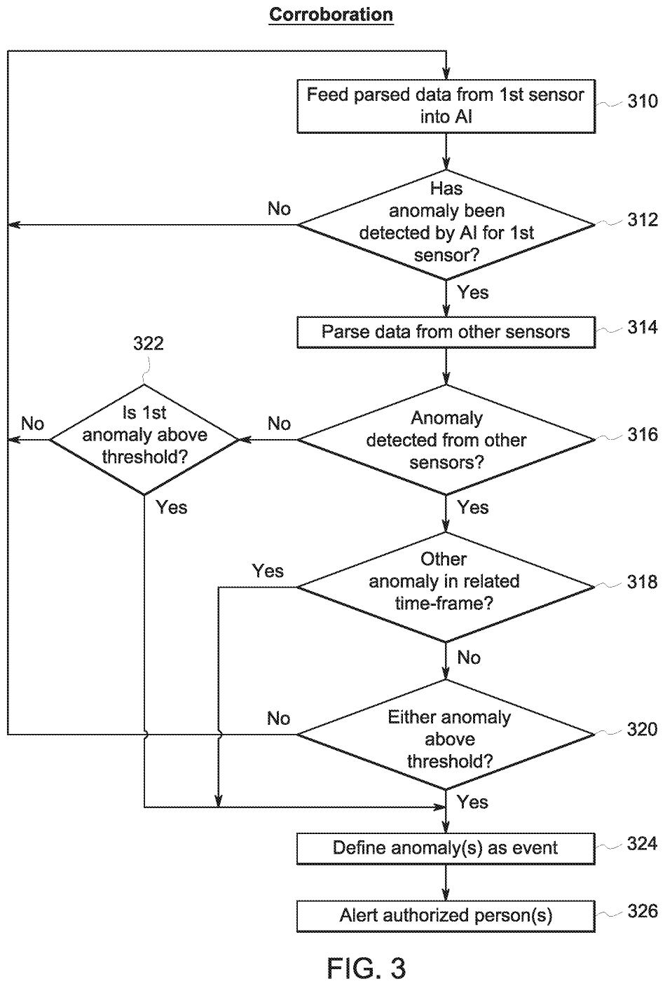

Another embodiment of the logic in making a determination, in this case, based on grading of an anomaly and/or corroboration between sensors is shown in FIG. 3.

Parsed data from a first sensor is fed into an AI system (step 310). Insofar as an anomaly is detected in the data (step 312), this is corroborated against data from at least one other sensor by parsing data from the other sensors that are involved in the particular implementation (step 314). In step 316 a decision is made whether any of the other sensor data shows up an anomaly, in which case it is compared on a time scale whether the second anomaly is in a related time frame (which could be the same time as the first sensor anomaly or be causally linked to activities flowing from the first sensor anomaly) (step 318). If the second sensor anomaly is above a certain threshold deviation (step 320) or, similarly, even if there is no other corroborating sensor data, if the anomaly from the first sensor data exceeds a threshold deviation (step 322), the anomaly captured from either of such devices triggers an event (step 324), which alerts one or more authorized persons (step 326).

As discussed above, real-time image data captured by the image sensor 104 is made available to first responders 112. In one implementation, the server processes the incoming data, validates the existence of a fire, smoke or potential carbon monoxide, makes a determination which responders to notify (e.g., fire department in the event of fire or smoke; ambulance or other health services if an occupant is determined to be at health risk), and makes the image sensor streaming data available to the first responders.

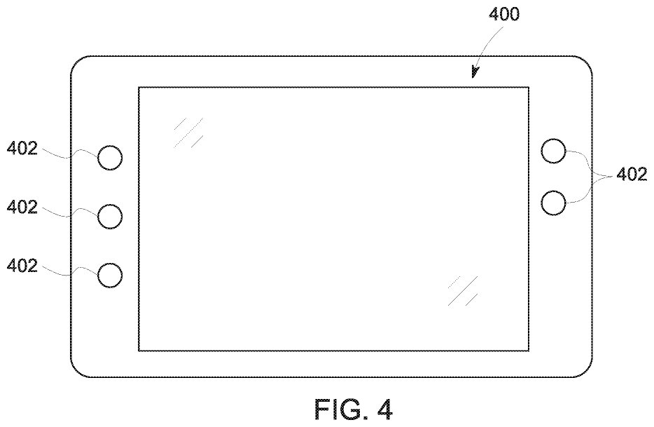

In one embodiment, the responders may also be provided with a link to the historical sensor data in addition to current streaming image or sensor data, or the responders may be in communication with the system of the present invention through a portal or other web page or software application (app) implementation, with access to the historical and/or current image data on the screen 400, and with the ability to bring up other sensor data, e.g. by clicking on the icons 402 as shown in one embodiment of a portal in FIG. 4.

In the case of a fire, firefighters will use the historic and/or current streaming data to assess the extent and location of the fire to determine the best location to enter the room or building. In addition, AI-enabled assessment of the data may provide opinions to the responders regarding the best options for entering the dwelling, or optimal or recommended actions based on the sensor data. For example, algorithms may define the origin and spread of a fire based on the order in which smoke or fire alarms were triggered. In one embodiment, where there are multiple adjacent rooms with multiple fire/smoke/CO sensors and multiple image sensors (e.g., one for each room) the system may define families of sensors that are related to each other, either by being part of the same dwelling or related by proximity. This allows all image sensors forming part of a family to be fed to responders to provide a broader overview of the extent of the fire or other emergency and how best to enter or otherwise respond.

The first or initial system communications system that triggers the alarm, may transmit the address of the dwelling based on an ID number for the sensor that triggered the alarm or ID number of the communications system, which may be stored in a database. This address can thus be transmitted to the responding third-party to define the location of the dwelling from which the alert is transmitting, and may simultaneously display the source of the alert on a map that may be presented to the responders on their display screens (cell phone, tablet, laptop, desktop, etc). Also the system can ensure that the alert is sent to the appropriate third-party based on the type of emergency. In another embodiment, the sensor may identify its position via GPS and thereby define its location and transmit this information instead. As discussed above, the interface used by the third-party may automatically draw the location of the alert on a map, optionally along with additional, pertinent information.

It will be appreciated that if the image data identifies a person in the building as being overcome by carbon monoxide (CO) or smoke inhalation or some other cause, the system will notify all relevant third-parties. In the case of a fire, this may include the fire department, who can then identify where victims may be located, as well as ambulance services/paramedics to treat the victims.

In the above embodiment, only a smoke sensor, carbon monoxide sensor or fire alarm 102 and an image sensor 104 were included. As mentioned above, the present invention contemplates any number of different sensors for detecting different emergencies, and capturing and transmitting information to the server 110. The data from the different sensors serves not only it identify possible events that may require a response, but help in corroborating potential events by verifying data from one sensor with data from another sensor.

According to one implementation, the data from the various sensors is analyzed by an artificial intelligence network to identify anomalies in the data, e.g., breathing data captured by an audio sensor to detect anomalies in the breathing patterns of an occupant, or data from the image sensor to determine abnormal variations from the usual sleeping patterns of an occupant. As discussed above, the system includes an algorithm (which typically will take the form of machine readable code on a storage medium controlling a processor at the server 110) to compare data from the various sensors to identify corroborating data to a potential triggering event, thereby allowing a triggering event to be confirmed and an alarm to be issued to relevant parties, including first responders based on location and the type of emergency, which will define the most appropriate first responders.

While the present invention has been described with reference to particular embodiments with specific physiological, imaging, auditory and medical sensors, it will be appreciated that different sensors and different configurations of the communication systems and server system can be implemented without departing from the scope of the invention.

What is claimed is:

1. An emergency alert and response system for a dwelling space, comprising
at least one dwelling sensor,
a communications system comprising at least one speaker and at least one microphone for hands free communication between the occupant and designated parties,
at least one image sensor for capturing image data, comprising one or more of cameras operating in the visual spectrum, image sensors operating according to different modalities such as direct-temperature sensing, ultrasonic motion detectors, and image sensors operating at different frequencies or in different frequency bands such as infrared, thermal, lidar, and radar, and
a processor connected to a memory configured by means of machine-readable code to identify emergency events based on the number of anomalies detected and/or based on corroboration of an anomaly by one sensor with data from at least a second sensor to define an emergency event, wherein the communications system is configured for real-time sensor data streaming from the at least one sensor to one or more designated third-parties or entities in response to an emergency event.

2. The system of claim 1, wherein the machine-readable code is configured to identify the appropriate designated third-parties or entities to contact via the communications system based on the type of emergency.

3. The system of claim 1, wherein the at least one dwelling sensor includes one or more of: a carbon monoxide detector, a smoke detector, a fire alarm, a stove-left-on alarm, a moisture sensor, a strain gauge for detecting shifts or movement in structural components of a home, thermal sensor, ultrasonic sensor, infrared sensor, a microphone listening for structural noises or other events that may be affecting a person in the residence, stove-left-on sensor, moisture sensor, strain gauge, accelerometer, fall detector and microphone.

4. The system of claim 1, further comprising an external monitoring system that includes the capture or relaying of public emergency reports and information.

5. The system of claim 1, further comprising at least one occupant sensor for monitoring physiological parameters of occupants of the dwelling, the at least one occupant sensor comprising one or more of: an imaging sensor, audio sensor, and one or more health monitors.

6. The system of claim 5, wherein the health monitors include one or more of a sphygmomanometer (blood pressure), heart rate, ECG, blood oxygenation, and/or genetic sensors.

7. The system of claim 4, wherein the external monitoring system includes monitoring devices for receiving public broadcasts and emergency notifications, including one or more of emergency broadcasts, reports and read-outs from earthquake sensors, weather alerts, tidal wave monitors, tornado and hurricane monitors and warnings, mass shooter alerts, infection disease warning, air raid warnings, and nuclear alerts.

8. The system of claim 1, wherein the real-time sensor data streaming includes streaming of imaging data in one or more frequency bands or formats, including visual, infra-red and radio.

9. The system of claim 1, wherein the communications system includes a voice activated system.

10. A method of enhancing the safety of an occupant of a dwelling space, comprising:
monitoring the dwelling space for safety concerns associated with the dwelling space by means of at least two safety sensor;
identifying potential emergency events based on safety sensor information;
verifying a potential emergency event that has been identified by one safety sensor, by means of information from at least a second safety sensor, and
in the event of an emergency event being verified, notifying at least one of: the occupant, and one or more of authorized third-parties that have been identified as being the most appropriate third-parties based on the nature of the verified emergency.

11. The method of claim 10, wherein the safety sensors include an image sensor, the method comprising providing said authorized third-parties with voice communication with the occupant, and live data streaming from one or more image sensors.

12. The method of claim 10, further comprising monitoring the occupant's health by means of safety sensors that include health sensor information and using an AI network to identify anomalies in the health sensor information over time or anomalies compared to other persons in similar situations.

13. The method of claim 10, further comprising monitoring emergency situations outside the dwelling space and notifying one or more of: the occupant and authorized third-parties of relevant events that may affect the occupant.

14. The method of claim 13, wherein monitoring of the dwelling space includes monitoring for unauthorized intruders.

15. The method of claim 11, wherein both image sensor data and other safety sensor data is provided to authorized third-parties, and includes at least one of historical data and real-time streaming data, to inform about one or more of: the nature of the emergency, the location of the emergency, the origin of the emergency, and the situation and location of the occupant.

16. The method of claim 15, wherein providing the authorized third-parties with voice communication with the occupant includes providing a voice-activated communications system in the dwelling space.

17. An emergency detector system for a building, comprising
at least one dwelling sensor,
at least one image sensor for receiving image data at one or more frequencies,
a processor connected to memory configured with machine-readable code defining an algorithm for analyzing the data from the at least one dwelling sensor and one or more image sensors to detect a potential emergency event and corroborate said event detected by one sensor with data from at least one other sensor, and
a communications system for alerting an emergency response team or other entity in the event of a corroborated emergency event, and providing them with access to at least one of: historical sensor data over time, and current streaming of sensor data from one or more sensor.

18. The emergency detector system of claim 17, further comprising a second communications system that includes a microphone and a speaker in the building for direct communication between the emergency response team or other entity and occupants in the building.

19. The emergency detector system of claim 18, wherein the at least one dwelling sensor includes one or more of: a carbon monoxide detector, a smoke detector, a fire alarm, a stove-left-on alarm, a moisture sensor, a strain gauge for detecting shifts or movement in structural components of a home, thermal sensor, ultrasonic sensor, infrared sensor, a microphone listening for structural noises or other events that may be affecting a person in the residence, stove-left-on sensor, moisture sensor, strain gauge, accelerometer, fall detector, and microphone.

20. The emergency detector system of claim 18, wherein one or more image sensors include at least one of an imaging camera operating in the visual spectrum, an image sensor operating in the infra-red spectrum, a lidar system, and a radar system.

21. The emergency detector system of claim 18, wherein the second communications system comprises a voice activated communications system.
